(19) United States
(12) Patent Application Publication
(10) Pub. No.: US 2007/0282640 A1
(43) Pub. Date: Dec. 6, 2007

(54) HEALTHCARE INFORMATION ACCESSIBILITY AND PROCESSING SYSTEM

(75) Inventors: Lawrence P. Johnson, Cochranville, PA (US); David R. Scheer, Morton, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: ALLMED RESOURCES LLC, Cochranville, PA (US)

(21) Appl. No.: 11/754,844

(22) Filed: May 29, 2007

Related U.S. Application Data
(60) Provisional application No. 60/808,794, filed on May 26, 2006.

(51) Int. Cl. G06Q 10/00; G06Q 40/00

(52) U.S. Cl. 705/4; 705/2

(57) ABSTRACT

The present invention is directed to a system for collecting, processing and providing access to healthcare treatment information. A first provider computer is provided for collecting and transmitting claim healthcare treatment information relating to a patient. The healthcare treatment information is communicated to a third party payer computer in communication with the first provider computer. A healthcare treatment information processing computer is provided in communication with the provider computer and the third party payer computer comprising computer software for collecting and processing the healthcare treatment information and adapted to display selected healthcare treatment information to a second provider. A method of collecting, processing and making available healthcare treatment information to providers is also provided. The method includes the steps of: entering healthcare treatment information relating to the treatment of a patient into a provider computer in communication with a claim intake system of a third party payer; communicating the healthcare treatment information to the third party payer; accessing the third party payer computer via a healthcare treatment information processing computer and extracting the healthcare treatment information relating to the treatment of the patient; and, providing access to the healthcare treatment information to a plurality of providers via a computer network.

### CROSS REFERENCE TO RELATED APPLICATION

This application claims priority from U.S. Provisional Application No. 60/808,794, “HEALTHCARE INFORMATION ACCESSIBILITY AND PROCESSING SYSTEM,” filed May 26, 2006, the entire contents of which is incorporated by reference as if fully set forth herein.

### FIELD OF THE INVENTION

The present invention relates to the field of healthcare information, and specifically, to systems for collecting, monitoring and analyzing healthcare information to provide a more complete picture of a patient's medical history.

### BACKGROUND

Individuals who seek or are in need of medical care (patients) are free to obtain the services of any medical provider they choose. Even within controlled healthcare networks (such as PPOs or other managed care systems) created by insurance companies (also known as “third party payers”), patients are free to obtain care from any healthcare provider (“provider”) within the network subject to certain treatment protocols.

Providers of healthcare, such as hospitals (i.e., institutional providers) and physicians (i.e., individual providers) (collectively, any healthcare provider referred to herein as a “provider”), are often called upon to provide services without the benefit of knowing about prior treatment history of the patient at other hospitals or physicians' offices. Such lack of knowledge creates problems from a treatment, billing and collections standpoint. This is due to the fact that each hospital and/or physician's office has a unique and separate computer database of treatment history on its own patients. Information is not shared across systems, and there is no central repository that provides access to an individual patient's past treatment history unless they return to the same provider for treatment. Even then, the availability of past treatment history is often not easily accessed by the provider. The unique disparity between each individual system, coupled with a total lack of connectivity between these systems, effectively eliminates access to valuable healthcare treatment information (or “HTI,” described in greater detail below) on patients.

When any provider of healthcare services treats a patient, they are required to submit a claim form to the patient's insurance carrier (if of course the patient is or was insured at some time) in order to be reimbursed for the healthcare treatment services provided. The claim, whether in an electronic or paper (hard copy) format, must contain pertinent identifying information related to the patient that allows for proper identification such as Social Security number, residence, insurance policy number, date of birth, etc. The claim must also contain the date(s) of service, identify the provider of service, enumerate the services provided by “CPT® code” (“common procedure terminology,” a five digit numeric identifier (“code”) for all recognized medical services) and include the clinical diagnosis on the reason and or outcome for each provided service. The CPT® is a uniform coding system consisting of descriptive terms and identifying codes that are used primarily to identify medical services and procedures furnished by physicians and other healthcare professionals, and is incorporated herein by reference as if fully set forth herein. Healthcare professionals including providers use the CPT® to identify services and procedures for which they bill public or private health insurance programs. CPT® is owned and published by the American Medical Association and is updated annually to reflect new, changed or obsolete procedures. CPT® is now in its fifth version (CPT-5®). Another healthcare procedure coding system is the Healthcare Common Procedure Coding System (HCPCS). Both the CPT® and the HCPCS are referred to herein collectively as “healthcare procedure coding systems” or “coding systems.” No claim for services is likely to be paid by any insurance carrier or other third party payer without the above information and a line item diagnosis by CPT® code.

Since all healthcare providers wish to be paid for their services usually on a timely basis, generally an appropriate claim submission is made by the provider to the insurance carrier shortly after treatment has been provided to a patient. At that point the insurance carrier has within its database the information pertaining to the treatment of a patient which would include the date of service, location of service, name of the provider, description of the services provided and why they were provided along with a treatment outcome if appropriate.

Unfortunately, at the present time, there is no access to this useful information by the provider community. Because information cannot currently be easily shared by different members of the healthcare team (e.g., physicians, hospitals, nursing homes, etc.), providers are often asked to rely upon a patient's own recollection in order to collect medical history information. Patients often have difficulty recalling their various physicians, diagnoses, current medications, and any past tests or studies performed.

It would be advantageous for providers to be able to access the insurer's or other third part payer's database, as its collects and contains all of the healthcare treatment information for various subscribers (patients) regardless of who the provider of services was, or where the provider is were located.

Healthcare facilities (i.e., hospitals, long-term care facilities, nursing homes, outpatient facilities, and the like) and other providers of medical treatment and related services should recognize the benefits of having access to a database of healthcare treatment information relating to their patients. Such access could provide vital, and perhaps life-saving, information regarding previous medical tests, treatments, prior illnesses and/or other medical events or conditions experienced by their patients. Likewise, valuable and important information concerning medications and prescriptions filled by a patient would be available if providers could access an insurer's database of collected healthcare treatment information. In addition, costly duplication of diagnostic testing such as lab work, MRIs and x-rays could be avoided if information were shared across a healthcare system. However, there is currently no readily available simple source for this information.

Patients who are beneficiaries of programs where third party payers are responsible for at least a portion of the patients' medical bills (e.g., Medicaid or Medicare), based upon need or desire, have the ability to receive medical services at different medical facilities and/or from multiple physician providers. For example, a patient beneficiary who lives and normally receives services in their local community may fall ill or be injured while visiting another community within the state. The healthcare facility and or provider called upon to treat the patient currently has no ability to readily access or even to be made aware of previous care provided to the Medicaid patient by another provider. Potentially important information regarding the patient's medical history may not be available to the remote provider, placing providers in a position of having to recreate information that already exists elsewhere, or to simply go without pertinent information relating to a patient's medical history.

Using a system that collects healthcare treatment information in a format where providers or other members of the healthcare team can easily access and review this critical information may lead to a more efficient and organized healthcare system. Without such a system, it is possible that providers may provide more extensive treatment then would otherwise have been necessary including the duplication of diagnostic testing such as x-rays, lab work, and cardiac work ups. Clearly, it would be a significant benefit to providers of healthcare services, as well as the well-being of the patient, for all providers to have access to each patient's medical treatment history. At present, this capability does not exist beyond each individual physician office or treatment facility.

### SUMMARY OF THE INVENTION

The present invention is directed to a system for collecting, processing and providing access to healthcare treatment information. A first provider computer is provided for collecting and transmitting healthcare treatment information relating to a patient. The healthcare treatment information is communicated to a third party payer computer in communication with the first provider computer. A healthcare treatment information processing computer is provided in communication with the provider computer and the third party payer computer comprising computer software for collecting and processing the healthcare treatment information and adapted to display selected healthcare treatment information to a second provider.

A method of collecting, processing and making available healthcare treatment information to providers is also provided. The method includes the steps of: entering healthcare treatment information relating to the treatment of a patient into a provider computer in communication with a claim intake system of a third party payer; communicating the healthcare treatment information relating to treatment of the patient to the claim intake system of the third party payer; accessing the claim intake system of the third party payer via a healthcare treatment information processing computer and extracting the healthcare treatment information relating to the treatment of the patient; and, providing access to the healthcare treatment information processing computer to a plurality of providers via a computer network.

The method of collecting, processing and making available healthcare treatment information to providers may also include the steps of: providing a healthcare treatment information processing computer including a database containing healthcare treatment information relating to the treatment of a patient; creating a provider profile including a unique identifier code and a respective password and storing the provider profile in the database; accessing the healthcare treatment information processing computer by providing the unique identifier code and a respective password; providing patient identification information for retrieving the healthcare treatment information; retrieving the healthcare treatment information from the database; and, communicating the healthcare treatment information to a provider computer.

### DESCRIPTION OF THE DRAWINGS

FIG. 1 shows schematically the computer network of the present invention connecting providers, third party payers, and the computer server of the present invention.

FIG. 2 shows schematically the flow of healthcare treatment information through the system of the current invention from providers, to a third party payer, to the computer server of the present invention.

FIG. 3 shows schematically the networked connectivity of providers and the computer server of the present invention. AMR-PT001.1

FIG. 4 shows schematically the networked connectivity of provider claim submission systems, third party payer submissions systems, and the computer server of the present invention.

FIG. 5 shows schematically the server side of the system of the present invention.

FIG. 6 shows schematically the flow of patient HTI from a first provider to a second provider utilizing the system of the present invention.

FIG. 7 shows schematically potential patient treatment outcomes based upon utilizing the system of the present invention.

FIG. 8 shows schematically an example of a process of a user signing up to utilize the system of the present invention and utilizing the system.

FIG. 9 shows schematically an example of a process of the computer server of the present invention.

FIG. 10 shows an example of an internet browser displaying an opening screen of a website of the system of the present invention.

FIG. 11 shows an example of an internet browser displaying a login screen of a website of the system of the present invention.

FIG. 12 shows an example of an internet browser displaying an options or user parameters screen of a website of the system of the present invention.

FIG. 13 shows an example of an internet browser displaying a patient search screen of a website of the system of the present invention.

FIG. 14 shows an example of an internet browser displaying a results screen of a website of the system of the present invention.

FIG. 15 illustrates a visit by a patient to a first provider having access to the system of the present invention.

FIG. 16 illustrates a visit by the patient of FIG. 15 to a second provider having access to the system of the present invention.

### DETAILED DESCRIPTION OF THE INVENTION

The present invention is directed to a system for providing relevant HTI to all providers based upon, or in response to, the submission of claims to third party insurance carriers (or any third party payer), in an organized, efficient and effective manner. Additionally, the system includes provisions for the gathering and developing HTI for the uninsured.

As used herein, the term “provider” refers to any person, company, facility or organization that provides healthcare and/or medical treatment and/or medical testing and/or medical diagnosis services.

As used herein, the term “third party payer” refers to any party other than a patient being treated that is responsible for paying at least a portion of the patient's medical costs, including, but not limited to, an insurer, insurance company, a governmental agency or program, a public assistance program, a charity, or the like.

As used herein, the term “HTI” is an acronym for “healthcare treatment information,” and generally relates to information related to the medical diagnosis or treatment of a patient, and may include, but is not limited to: health insurance information including, but not limited to, coverage, billing, co-pays an payments; dates of service; patient demographic information; healthcare procedure coding systems; patient medical history; disease states; medications; drug interactions; drug allergies; past side effects; lab tests; medical tests (results, history); lab test results; physical therapy; surgical procedures; patient payment history, or any other relevant information related to medically diagnosing and/or treating a patient.

As used herein, the term “patient” refers to any person seeking medical services of any kind, whether for treatment, diagnosis, testing, surgery, counseling, or any other healthcare related matter.

As used herein, the term “user” refers to any person (e.g., provider, third party payer, or other user of the system) utilizing the system of the present invention.

The core of the system of the present invention is a networked computer with software adapted to provide an interface with and between any provider's or third party payer's claim computer healthcare insurance claim submission process and/or software and/or computer equipment. A computer network is used for facilitating communication between the different components of the system.

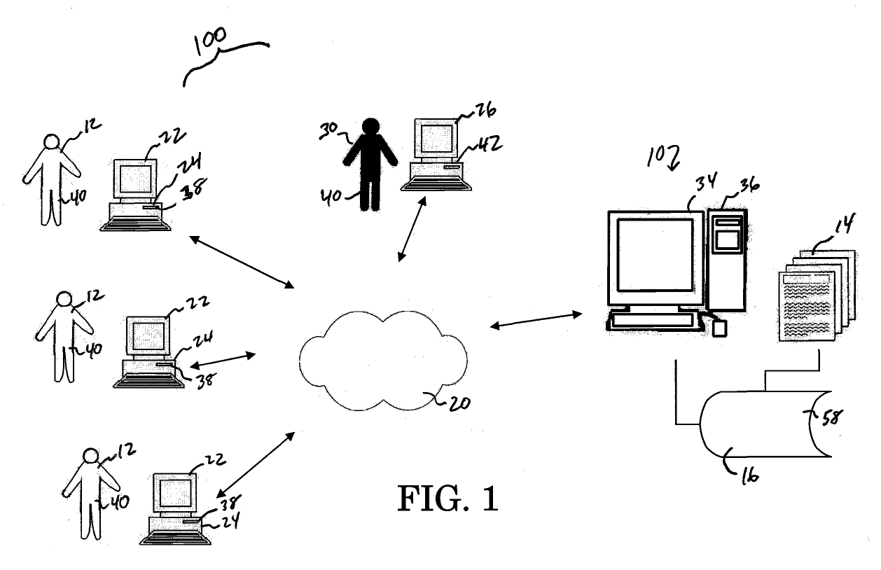

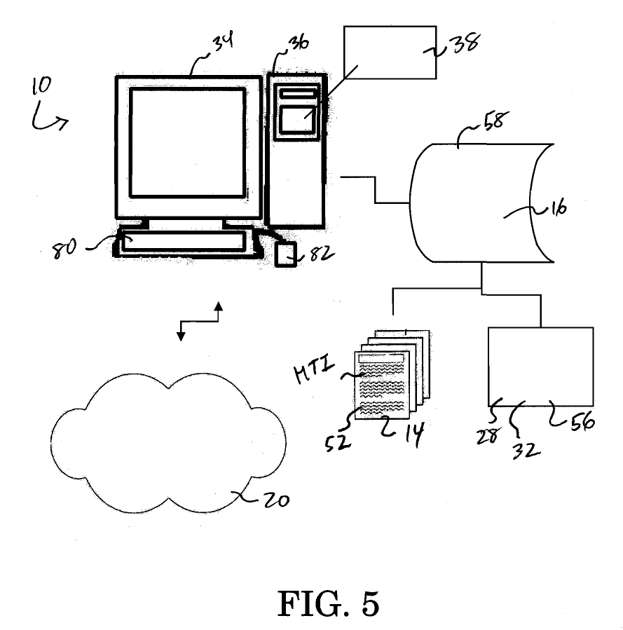

The overall system of the present invention will be referred to herein as the Comprehensive Health and Treatment Record System or “CHATR System” depicted generally in the Figures as 100. FIGS. 1-4 illustrate the networked system of the present invention, including the communication of information between and among a provider 12 and the core of the system, which is preferably a computer server 10 (the “CHATR server”). As shown in FIG. 5, the CHATR server 10 is a computer 34, and can comprise a processing device or central processing unit (CPU) 36, memory (storage) 58, one or more user interface devices (keyboard 80, mouse 82), a display (monitor) 84, and one or more network interface devices, or any combination thereof. The CHATR server 10 comprises software 38 for running the CHATR System 100.

It is appreciated that CHATR System 100 users 40 may be any providers 12, third party payers 30, or any other party having a stake in the healthcare treatment and/or reimbursement system. In most cases, the user 40 will be a provider 12 that has subscribed to be a member of the CHATR System 100, and

FIGS. 1-4 illustrate schematically the CHATR System 100 connecting providers 12, third party payers 30, and CHATR users 40 via a computer network 20 to the CHATR server 10. The CHATR server 10 preferably includes a computer 34 with an acceptable storage capacity (memory) 58, computer software 38, and/or any combination thereof, that is in communication with and serves “client side” provider computers 22, described in greater detail below. The CHATR server 10 is adapted to maintain a database 16 of information, particularly HTI, collected from various sources including providers 12 and third party payers 30. The information collected in the database is utilized to create a CHATR record 14, as described in greater detail below.

As shown in FIG. 1-4, access to the CHATR System 100 will preferably be via a computer network 20 such as the internet “world wide web” or any other computer network, and will be easily accessible to any provider 12. In order to access the CHATR System 100, a user 40 will be required to have the necessary protocol, such as programmed in proprietary software 38, installed on their provider computer workstation 22 (e.g., the computer or terminal used by the provider for entering HTI and processing and/or submitting claims to third party payers 30, and having network access). A provider computer workstation 22 is a computer, and can comprise a processing device or central processing unit (CPU), memory (storage), one or more user interface devices (keyboard, mouse), a display (monitor), and one or more network interface devices, or any combination thereof.

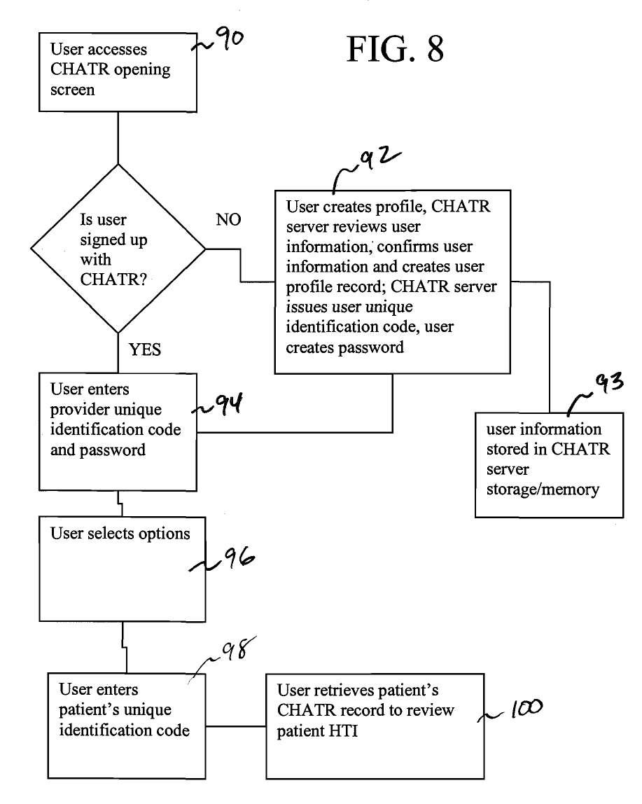

As illustrated in FIG. 8, each user 40 (e.g., a provider 12) will provide information necessary for signing up to be a part of and have access to the CHATR System 100. A user 40 will initially access the CHATR System 100 opening screen (FIG. 8, 90). If the user 40 is not signed up to be a part of the CHATR System 100, the user 40 will create a user profile (FIG. 8, 92). The user 40 will provide information so that software of the CHATR server 10 can verify the accuracy of the user's information. Thus, the CHATR server 10 may include a database of information necessary to verify the identity of a user 40 such as a provider 12 or a third party payer 30. A unique identifier code 28 will be generated by the CHATR server 10 when a user 40 such as a provider 12 signs up to be a participant in the system and creates a user profile 56 (FIG. 8, 92). When creating a user profile 56, the user 40 will select a password 32 that will be cross-referenced to the user's 40 unique identifier code 28. It is contemplated that the system 100 will require both a unique identifier code 28 and a password 32 for accessing the system 100. The user's information is stored in the memory 58 (e.g., computer storage) of the CHATR server 10 (FIG. 8, 93).

When logging in to the CHATR server 10, the user 40 will enter the unique identification code 28 and password 32 (FIG. 8, 94). The user 40 may then select from various options relating to how the user 40 wishes to receive information from the CHATR database 16 and the appearance of the information CHATR record 14 on the user's 40 computer 22 monitor (FIG. 8, 96). The user 40 will enter a patient's unique identification code 52 (FIG. 8, 98), described in greater detail below. The CHATR server 10 will then provide the user 40 information from the patient's CHATR record 14 (FIG. 8, 100).

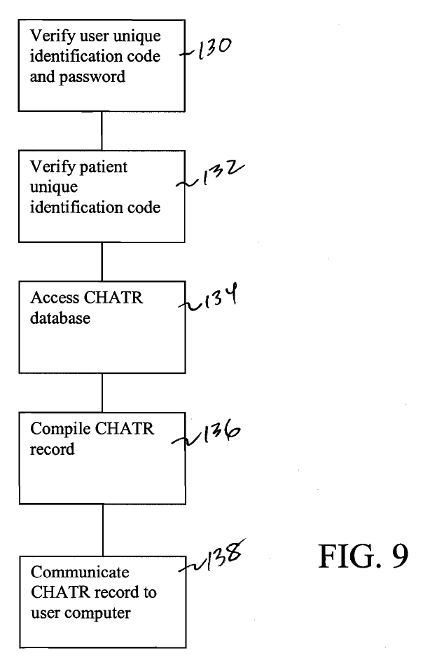

The process performed by the software 38 of the CHATR server 10 for verifying provider 12 information and retrieving HTI is shown schematically in FIG. 9. When a user 40 such as a provider 12 enters the user's 40 unique identification code 28 and password 32, the software 38 of the CHATR server 10 verifies the unique identification code 28 and password 32 by checking information against the information of the user's profile 56 stored in the CHATR database 16 (FIG. 5; FIG. 9, 130). Upon logging in, a user 40 will enter the patient's unique identification code 52 to retrieve patient HTI. The software 38 of the CHATR server 10 verifies the patient's unique identification code 52 (FIG. 9, 132) by accessing the CHATR database 16 (FIG. 9, 136). Upon verifying the patient's unique identification code 52, the software 38 of the CHATR server 10 compiles the patient's CHATR record 14, containing HTI specific to that patient (FIG. 9, 136). The CHATR record 14 is then communicated to the user 40, via the computer network 20 (FIG. 9, 138).

A record created for and maintained by the CHATR System 100 is referred to herein as the as a CHATR record 14 or record, as shown in FIGS. 1, 4 and 5. The CHATR records 14 are collected and stored in the memory/storage 58 of the CHATR server 10, and may be maintained in a CHATR database 16. The CHATR computer 34 includes software and is preferably in communication with and/or comprises a client server running the software 38 for implementing the CHATR System 100. Access to CHATR server 10 will be via a computer network 20, such as a global network such as the internet (world wide web), and will be easily available to any provider 12 of medical services that has obtained a unique identifier code 28, set up a password 32 and installed any necessary software 38 on the provider's 12 computer 22. It is contemplated that it will be necessary to have the proper protocol program software 38 installed on a provider's computer workstation 22 to communicate with the CHATR server 10. Other connectivity software, as is known in the art may also be installed to facilitate integration and communication with the CHATR System 100. In addition, in one embodiment of the present invention, a user's computer 22 may interface with the CHATR server 10 via an internet browser 78 (such as MICROSOFT INTERNET EXPLORER, MOZILLA FIREFOX, or any other browser) without the need for any special proprietary software.

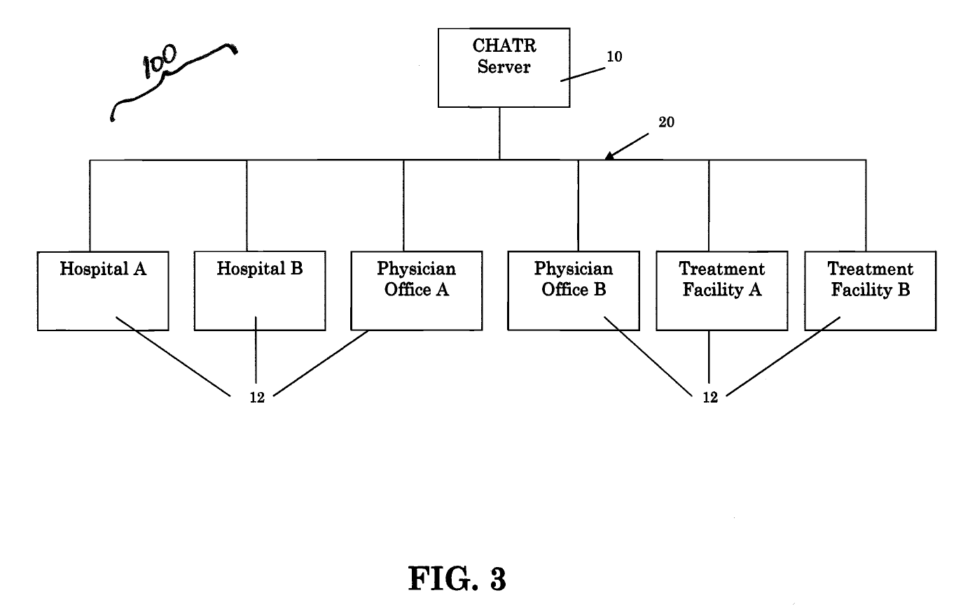

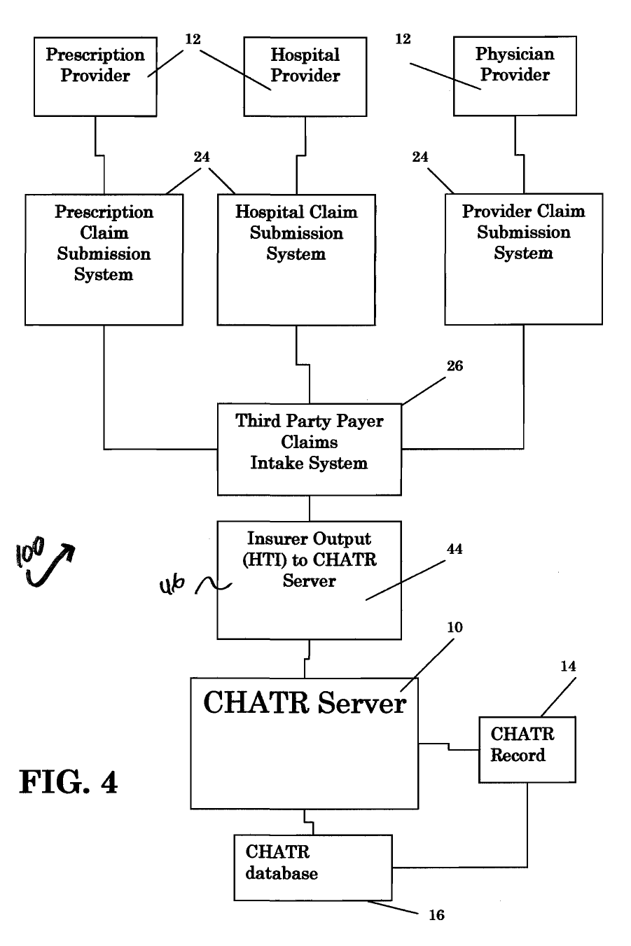

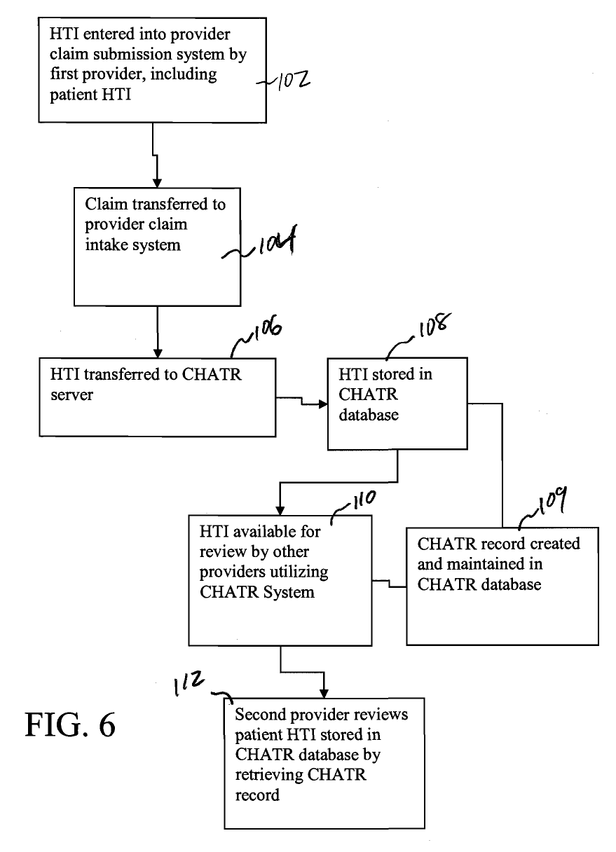

As shown in FIGS. 3-4, in general, providers 12, such as prescription providers (e.g., pharmacies), hospital providers (or other inpatient service providers), outpatient service providers, long-term care facilities, nursing homes or assisted living providers, or physician providers (e.g., family or general practice providers or non-hospital specialists) receive patients 50 for treatment or for filling prescriptions (in the case of a pharmacy provider). Information relating to the patient's HTI including any insurance claim information and is referred to herein as claim information 46, and the record containing or representing the claim information 46 is referred to herein as a claim 44. As shown in FIG. 6, the claim information 46 is generally entered into a provider's claim submission system 24 (FIG. 6, 102), which generally takes the form of a computer 42 (FIG. 1) including the necessary software for processing and submitting claims 44 to a third party payer 30 over a computer network. The claim submission systems 24 generally transfer claim information 46 to a claim uptake or claim intake system 26 (generally a computer such as computers 22 including software for accepting and processing insurance claims) of a third party payer (insurer) 30 (FIG. 6, 104), where the claim information 46, including the HTI and any other related information or information about the patient of medical service, necessary to process the claims 44 relating to a particular patient 50 submitted by the provider 12 are collected and processed (FIG. 4). The claims 44 may be processed and reviewed by the third party payer 30. This process may be in part automatic and performed by the software of the claim intake system 26. According to the system of the present invention, the claim uptake system 26 is part of the CHATR System 100, and is in communication with, and shares information with, the CHATR server 10.

The claim 44 is transferred to the CHATR server 10 (FIG. 4; FIG. 6, 106). The CHATR System 100 may collect and/or retrieve the claim 44 including the claim information 46 from the claim uptake system 26, and extracts the HTI for storage in the CHATR database 16 (FIG. 6, 108), and is further adapted to organize and/or otherwise process the HTI if necessary or as required. A CHATR record 14, stored in the CHATR database 16, may be created for each patient, provider and/or third party payer as a computer record including pertinent HTI for utilization by the CHATR System 100 and review by users 40 (FIG. 6, 108). The information pertaining to the patient's HTI is stored in the CHATR database 16 for access by CHATR System users 40 (FIG. 6, 110). A user 40 of the CHATR System 100, such as a second provider, can access and review a patient's HTI stored in the CHATR database 16 such as through retrieval of the CHATR record 14 (FIG. 6, 112).

The CHATR System 100 can be designed to perform various operations on the HTI collected based on the needs of a user 40. For example, the software of the CHATR server 10 can be designed and adapted to process and organize HTI based on various categories such as, by way of example: patient name; disease state(s); results of any medical tests; prescription medications; drug interactions; side effects; prior diagnoses; type of health insurance; family history; lab results; or any other HTI or related information that is entered into the system. The software of the CHATR server 10 may be designed and adapted to code the HTI for inclusion in particular a CHATR record 14. The HTI is preferably collected, organized and/or processed by the CHATR server 10 so that the information may be presented to a user 40 in a manner that is efficient and useful, with the goals of the system 100 including, but not limited to: the prevention of over-utilization of healthcare resources; increased level of patient care based upon provider access to shared HTI; and, providing a resource for providers to access patient history.

In one embodiment, the CHATR server 10 collects information (such as by accessing third party payer 30 claim intake systems 26 and extracting HTI) at set time intervals and creates and/or updates the existing CHATR database 16 and/or CHATR records 14 during these pre-selected time intervals. By way of example and not by way of limitation, the CHATR System 100 may be pre-programmed so that the CHATR server 10 downloads and reviews all information collected from providers 12 and third party payers 30 every hour or every four (4) hours, and generates an updated record 14 upon each review.

Alternately, a CHATR record 14 may be generated each time a provider's computer 22 calls for information from the CHATR server 10 about a particular patient through the information network 20 of the system. For example, all relevant HTI and related information collected from providers 12 and/or third party payers 30 may be collected and stored in a the CHATR database 16. The HTI may be coded, with cross referencing to each patient's unique identifier 52, each provider's unique identifier 28, and each third party payer's unique identifier 54. The software of the CHATR System 100 is designed having capabilities to access, collect, organize and/or retrieve any HTI entered through a provider's 12 computer 22 or a third party payer's 30 computer 48.

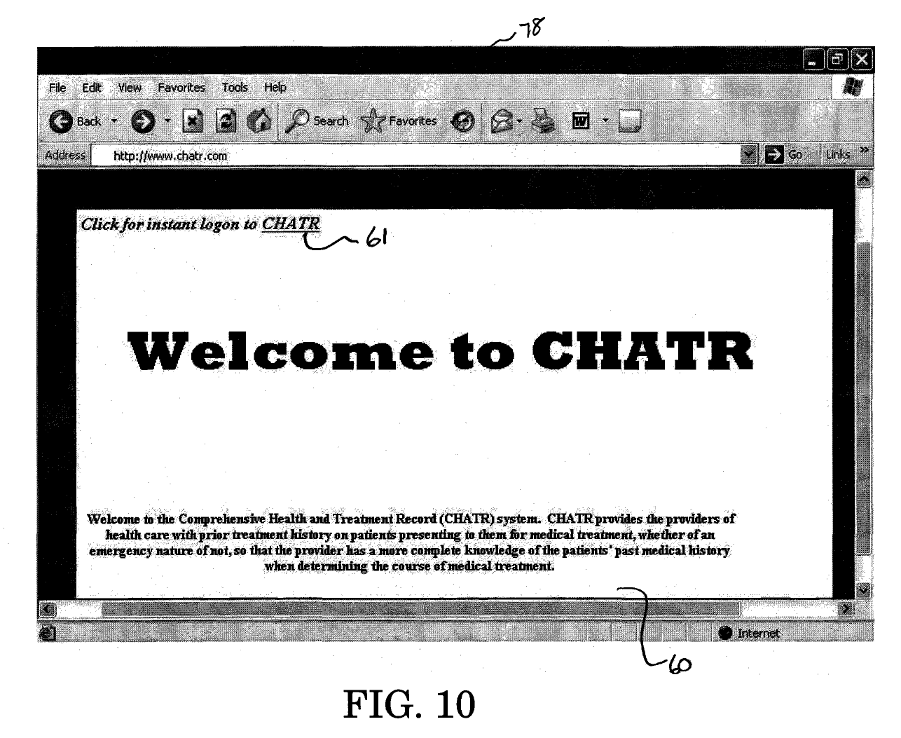

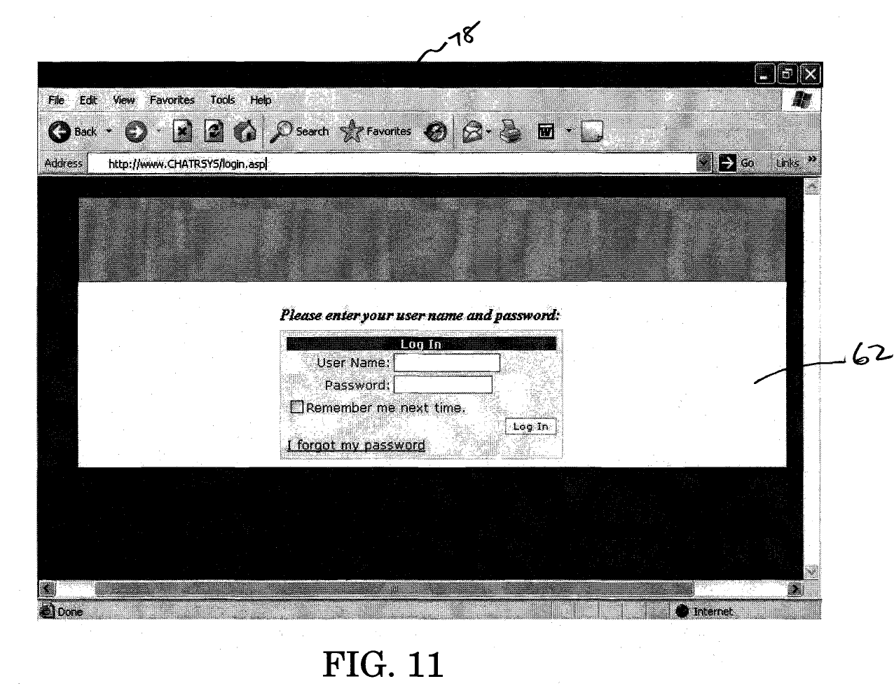

FIG. 10 shows an illustrative internet browser 78 of a provider computer 22, with an example of an opening screen 60 that may appear on a user's computer 22 for accessing patient information from the CHATR System 100. The opening screen 60 may be used to provide general information to CHATR System users, such as information regarding the computer network, an outline of the CHATR System, a user manual (including a downloadable version of the user manual), healthcare information, etc. The opening screen 60 preferably includes a link (hyperlink) 61 to a login screen 62 (FIG. 11). Upon accessing the login screen 62, a CHATR System 100 user 40 first enters their CHATR user identification (shown in FIG. 11 as “user name”), which may be the unique identifier code 28, and a password 32 associated with the code 28.

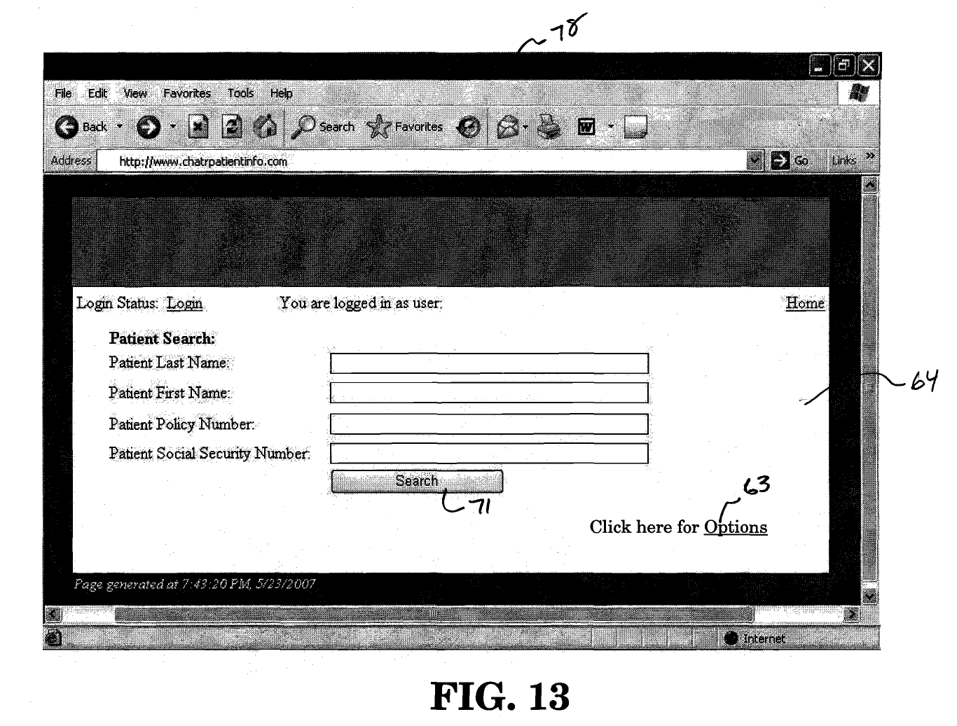

Upon logging in to the CHATR server 10, the user will be directed to a Patient Information Retrieval screen 64, and example of which is shown in FIG. 13. When a CHATR System 100 user 40 would like to check, for example, a patient's 50 treatment history or medical history, the user 40 may enter the patient's name or an identification code 52. The identification code could be a unique identification code 52 generated by the CHATR System, the patient's medical insurance ID code, the patient's Social Security number, or another identifying code that is secure and uniquely identified with a particular patient 50.

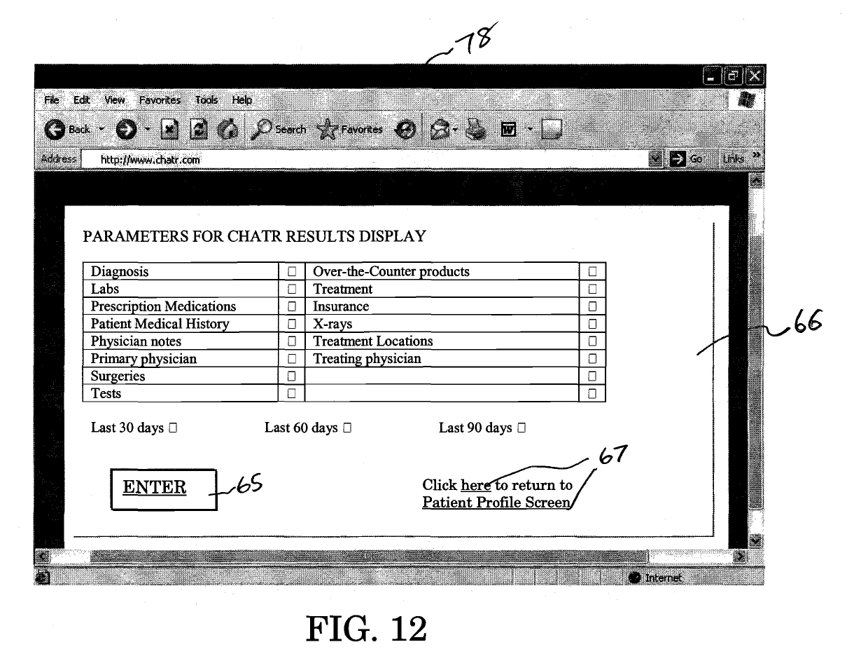

A CHATR System user 40 may enter a patient's name or ID code in the spaces provided on the Patient Information Retrieval screen 64. As shown in FIG. 13, the Patient Information Retrieval screen 64 may include a link (hyperlink) 63 to an Options or Parameters screen 66, shown in FIG. 12, which display various user-selectable options and/or parameters for retrieving a patient's HTI. The CHATR System user 40 will select the parameters for which they seek information and click the “enter” button 65 or click the link 67, returning to the Patient Information Retrieval screen 64.

A user 40 will click the “Search” button 71 of the Patient Information Retrieval screen 64 to initiate a retrieval of the CHATR record 14 for a patient 50. As shown in FIG. 8, the software of the CHATR server 10 is adapted to take the user's parameters and search the CHATR database 16, compiling the CHATR record 14 containing the patient's HTI. The software of the CHATR server 10 may also adapted to access on demand various networked databases, such as networked third party payer databases and provider databases, in order to incorporate such information into the CHATR database 16 to achieve an up-to-date CHATR record 14.

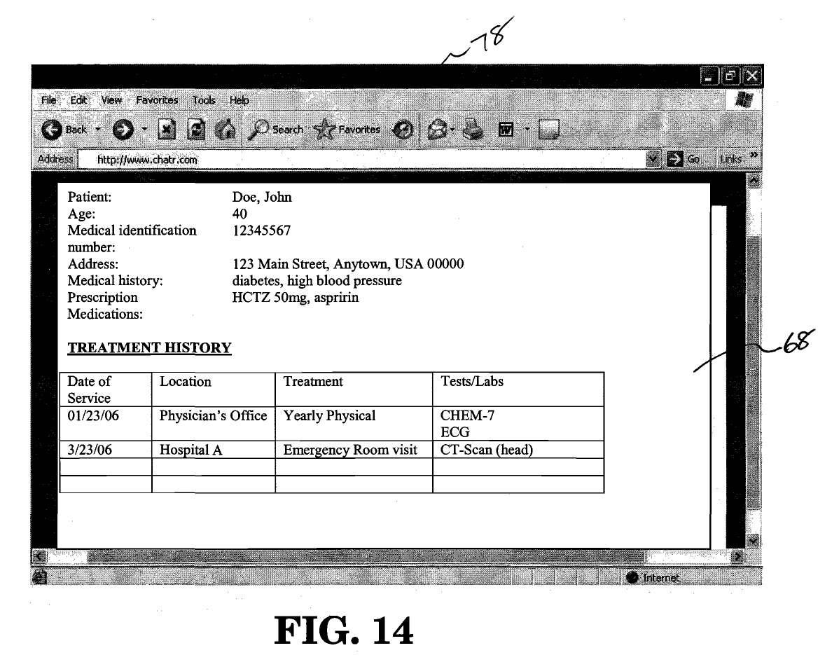

FIG. 14 shows an example of the output display of information from a patient's CHATR record 14 on a user's computer Results screen 68 showing an example of the results of a search of the CHATR database 16 for a particular patient's HTI. The Results screen 68 may include various figures, graphics, rows, boxes and/or columns, or any other display arrangement that allows a user to easily read, review and/or assess a patient's HTI. The CHATR System 100 preferably includes options allowing a user to customize the appearance of its screen and results, and sort the results by, for example, patient first or last name, treatment date, treatment of visit location, etc.

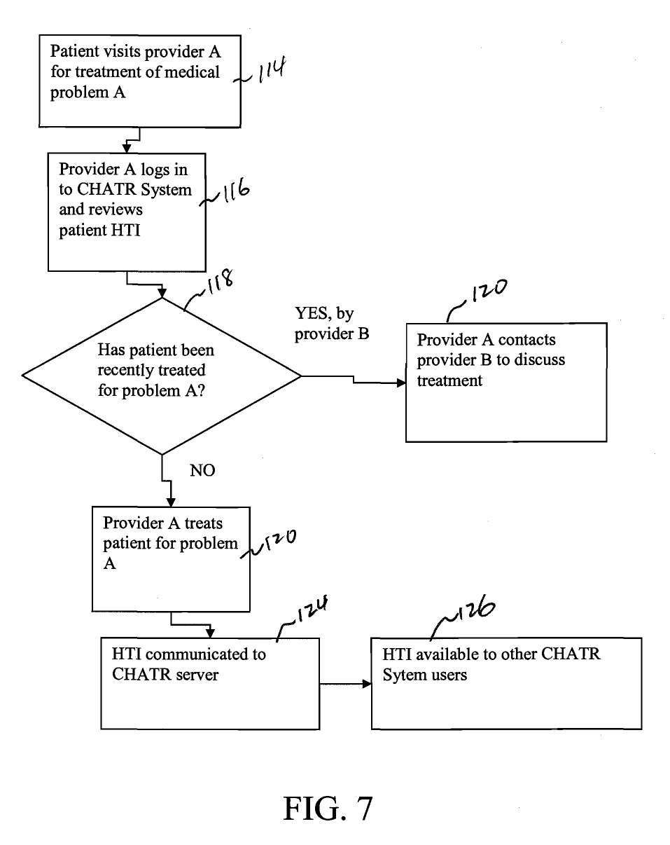

As a first illustrative example of the CHATR System 100, a patient 50 may visit a first provider 12, e.g. provider A, for treatment of a first medical problem, e.g. problem A (FIG. 7, 114). Provider A logs into the CHATR System 100 to review the patient's HTI as found in the CHATR record 14. (FIG. 7, 116). The provider 12 reviews the CHATR record 14 generated by the CHATR server 10 to determine whether the patient has been recently treated for problem A (FIG. 7, 118). If the patient has been recently treated, the provider 12 may wish to intervene, such as by contacting the earlier provider (in the example, provider B), to discuss the patient's treatment (FIG. 7, 120). It is appreciated that the CHATR record 14 will include any patient medications, lab tests, or other HTI relating to the patient, so that provider A is well informed when contacting provider B. If the patient has not been previously treated for problem A, the provider will treat the patient (FIG. 7, 122). The HTI will be entered into the CHATR System 100, when the will submits a claim 44, which will be communicated from the provider's claim submission system 24 to a third party payer's claim intake system 26, and the HTI will be communicated to the CHATR server 10 (FIG. 7, 124). The HTI will now be available to other users 40 of the CHATR System 100, such as another provider 12 (FIG. 7, 126).

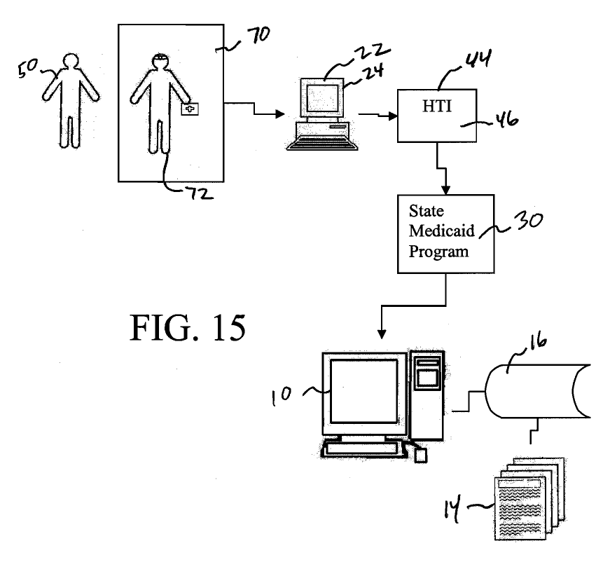

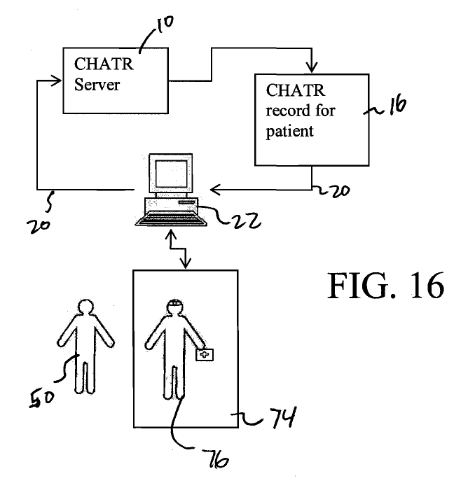

The system of the present invention may be further illustrated by describing a typical healthcare treatment scenario, and tracing patient information and HTI through the CHATR System 100. In this illustrated example, shown in FIGS. 15-16, an individual patient 50 presents for treatment at the emergency room of a hospital A 70 and sees an emergency room physician 72 (e.g., an institutional provider). The patient 50 complains of a severe headache and is also complaining of dizziness. The emergency room physician 72 on duty (provider) orders a series of lab tests and a CT-scan of the patient's head. In addition, the physician performs a complete work-up on the patient checking vital signs and getting a family history. The physician also discusses with the patient medications the patient is taking. In this example, the patient is taking a prescription medication for high blood pressure, but doesn't have the prescription or medication with him and does not know the name of the drug. In this case all the tests are normal as is the CT-scan of the head and the lab work. In the course of the three hours the patient spent in the emergency room, the headache and dizziness subsided and the patient was released. The emergency room physician's diagnosis concluded that the patient simply had “too much to drink” the night before. The hospital 70 utilizes its provider computer 22 as a claim submission system 24 to submit a claim 44 containing claim information 46 to the third party payer 30 (patient's insurance carrier, in this case the State Medicaid program) for payment including all the necessary HTI regarding treatment, testing and diagnosis.

In this example, the third party insurer (third party payer 30) is the State Medicaid program. The CHATR server 10 accesses the claim 44 information submitted by hospital A to the State Medicaid program within, for example, ten (10) days of the patient's visit to the emergency room of hospital A 70. This claim 44 data may be automatically collected by the CHATR server 10 and stored in the CHATR database 16 in a data file (e.g., the CHATR record 14). The CHATR server 10 may collect information such as in an electronic data file from the State Medicaid program (the third party payer 30) that includes all claims, regardless of whether or not they are eligible for payment, submitted to the State Medicaid program (the third party payer 30) by all providers 12 who treated patients 50 covered by this third party payer 30. The CHATR serer 10 now has this particular patient's information on the emergency room visit to hospital A 70 stored in the CHATR database 16 and available for access to a CHATR user 40 as part of a CHATR record 14.

Continuing with the illustrative healthcare scenario, and as represented schematically in FIG. 16, three weeks later the same patient 50 presents at the emergency room of hospital B 74 on the opposite side of the town in which the patient 50 resides (or at any other separate location different from the emergency room visit). The patient 50 is once again concerned about a severe headache and dizziness and is too embarrassed to mention his visit to hospital A 70 three weeks earlier. The emergency physician 76 at hospital B goes to a computer workstation 22 in the department that is connected via a computer network 20 to the CHATR server 10, and quickly accesses the CHATR database 16 and CHATR record 14. The physician 76 enters hospital B's unique Medicaid provider number and also the Medicaid ID number for the patient into a computer 22 having internet access to the CHATR sever 10 such as through an internet web browser 78, and/or a dedicated computer software program for accessing the CHATR System. The software of the CHATR server 10 verifies the access identification codes and any password entered by the physician 76. The CHATR server 10 retrieves the patient's HTI as a CHATR record 14 that is displayed for the emergency physician 76 at hospital B 74 on the computer 22 screen. The information displayed on the physician's 76 computer 22 may be user-selected, as described above.

In this example, as a participant in the CHATR System 100 of the present invention, the physician 76 is able to review the information from the patient's CHATR record 14 stored in the CHATR database 16 and determines that the patient 50 visited hospital A 70 three weeks earlier with the same symptoms. The physician 76 is also able to access the results of the lab tests and the results of the CT-scan of the head that were previously performed at hospital A. The physician 76 is also able to call up and review the exam level preformed by the physician 76 at hospital A 70 and the prior diagnosis and treatment.

Because the physician 76 is able to access the CHATR record 14, and utilize the CHATR System 100 to review prior treatment history and other patient-specific HTI, the physician has access to healthcare tools not previously available. Rather than redundantly ordering or repeating the same costly tests or procedures already completed a few weeks earlier, the physician 76 may ask the patient if the patient had been drinking the night before. The patient indicates he had indeed been drinking the night before. The physician is able to provide the proper counseling, such as giving some stern advice regarding alcohol consumption and instructing the patient to take some aspirin and go home and rest. In this example, the total time for this encounter at hospital B 74 is approximately twenty-five minutes, and no expensive tests or extensive treatments were necessary, due to the provider's ability to access information from the CHATR database 16 utilizing the CHATR System 100. A great deal of time, money and resources were saved through the use of the CHATR System 100.

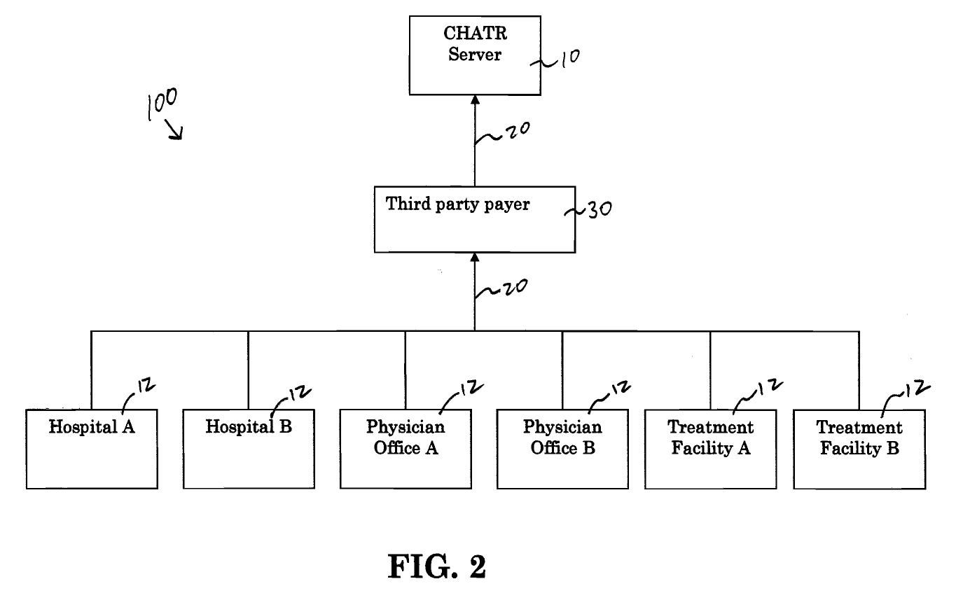

The accessibility of the CHATR System 100 across a variety of healthcare practices and locations is schematically depicted in FIGS. 2-3. Each of the facilities and providers 12 shown in FIG. 2-3 have computer network access, such as via the internet, to the CHATR System 100. Each provider 12 is able to increase efficiency, decrease costs, and increase healthcare effectiveness by using the CHATR System 100. The CHATR System 100 can be designed for generating reports to either providers, third party insurers, or governmental agencies. Such reports may be crucial in determining patterns of abuse, overuse, underutilization, redundant payments, etc.

The CHATR System 100 can, on a preset interval and/or real-time basis, receive all claim submission data and HTI from participating third party payers 30. The CHATR proprietary software processes the data received, stores the data in the CHATR database 16 and makes the data available to all subscribing medical providers 12 in an easy to access, user-friendly fashion, such as through any computer having internet access. The CHATR System 100 provides an inquiring provider with, for example, dates of service, treatment history, identifies who provided the services and supply the diagnosis and or chief complaint at the time of treatment.

The CHATR System depends, in part, upon receiving data from various third party payers 30 (e.g., insurance companies, carriers, government programs, and the like). The CHATR System 100 is capable of receiving HTI from as many third party payers 30 as wish to provide access to the HTI, and of providing access to as many providers 12 as wish to access it, such as through a subscription service. Given the potential for the improvement in the quality of care to patients along with the potential cost savings coming from elimination of duplicated services we anticipate that the invention will be widely accepted and in fact sought after by both providers and insurers. An advantage of the present invention is that neither participating insurance companies nor the provider community need be concerned about the capabilities or compatibilities of their own computer systems. The software of the CHATR System 100 will interface and integrate with any information system and can be installed on any provider workstation that has internet access.

The system of the present invention addressed various issues with the current manner in which healthcare information is accessed and shared by various members of the healthcare system. By providing a system where providers can access up-to-date patient treatment information from other providers, the present system accomplishes the goals of decreasing duplication of laboratory tests, decreasing the incidence of medical errors, decreasing the incidents of medication errors, and decreasing the readmission rates for patients recently treated.

It is contemplated that the CHATR System 100 will include safeguards to protect both patient privacy and proprietary information of third party payers. The system will be designed so that access to a patient's CHATR record 14 will be limited to parties having a patient's unique identification information. In addition, proprietary information of a third party payers will not be required to be shared with any other third party payer or provider. The system may be designed limiting shared information to HTI necessary for reviewing a patient's medical history.

Providers will benefit by using the CHATR System 100 of the present invention. Better patient care results in improved outcomes. Patient satisfaction will be increased. Medication or medical errors due to over-utilization or overlapping treatments will be decreased. Efficiency will be increased due to better use of staff and resources. Patient satisfaction will increase due to more informed treatment.

Third party payers will benefit by using the CHATR System 100 of the present invention. Lower operating costs will result while improving patient outcomes. Increased efficiencies will result from proper utilization of resources and personnel. Patient satisfaction will increase due to more informed treatment.

While the invention has been described in detail above, the invention is not limited to the specific embodiments described which should be considered as merely exemplary. Further modifications and extensions of the present invention may be developed and all such modifications are deemed to be within the scope of the present invention as defined by the appended claims.

What is claimed is:

1. A system for collecting, processing and providing access to healthcare treatment information, comprising:
a first provider computer for collecting and transmitting claim healthcare treatment information relating to a patient;
a third party payer computer in communication with the first provider computer for collecting the healthcare treatment information;
a healthcare treatment information processing computer in communication with the third party payer computer comprising computer software for collecting and processing the healthcare treatment information and adapted to display selected healthcare treatment information to a second provider.

2. The system of claim 1, wherein the first healthcare provider computer includes a claims submission system.

3. The system of claim 2, wherein the third party payer computer includes a claim intake system.

4. A method of collecting, processing and making available healthcare treatment information to providers, comprising the steps of:
(a) entering healthcare treatment information relating to the treatment of a patient into a provider computer in communication with a claim intake system of a third party payer;
(c) communicating the healthcare treatment information relating to treatment of the patient to the claim intake system of the third party payer;
(d) accessing the claim intake system of the third party payer via a healthcare treatment information processing computer and extracting the healthcare treatment information relating to the treatment of the patient; and,
(e) providing access to the healthcare treatment information processing computer to a plurality of providers via a computer network.

5. The method of claim 4, further comprising the step of treating a patient and collecting healthcare treatment information, prior to step (a).

6. The method of claim 4, wherein the plurality of providers are selected from the group consisting of hospitals, physicians, long-term care facilities, pharmacies, nurses, and treatment programs.

7. The method of claim 4, wherein step (e) further comprises storing the healthcare treatment information relating to the treatment of the patient in a database.

8. The method of claim 7, further comprising compiling a record of the healthcare treatment information relating to the treatment of the patient for access by a plurality of providers via a computer network.

9. A method of collecting, processing and making available healthcare treatment information to providers, comprising the steps of:
(a) providing a healthcare treatment information processing computer including a database containing healthcare treatment information relating to the treatment of a patient;
(b) creating a provider profile including a unique identifier code and a respective password and storing the provider profile in the database;
(c) accessing the healthcare treatment information processing computer by providing the unique identifier code and a respective password;
(d) providing patient identification information for retrieving the healthcare treatment information;
(e) retrieving the healthcare treatment information from the database; and,
(f) communicating the healthcare treatment information to a provider computer.

10. The method of claim 9, further comprising the step of treating a patient and collecting healthcare treatment information relating to the treatment of a patient before step (a), and wherein the healthcare treatment information relates to the patient in step (a).

11. The method of claim 9, further comprising, prior to step (a), the steps of entering healthcare treatment information relating to a patient into a provider computer, communicating the healthcare treatment information relating to the patient to a third party payer computer, and wherein the healthcare treatment information processing computer of step (a) is in communication with the third party payer computer and collects the healthcare treatment information from the third party payer computer.

12. The method of claim 9, wherein step (e) further comprises creating a record relating to the healthcare treatment information.
